(19) United States
(12) Patent Application Publication
(10) Pub. No.: US 2008/0095621 A1
(43) Pub. Date: Apr. 24, 2008

(54) Modular wind turbine with multiple micro wind turbine units

(76) Inventor: Yung-Hsin Chi, Taipei County (TW)

Correspondence Address: Chi, Yung-Hsin, 20525 Via Talavera, Yorba Linda, CA, 92887, US

(21) Appl. No.: 11/584,174

(22) Filed: Oct. 23, 2006

(51) Int. Cl. F03D 7/02

(52) U.S. Cl. 416/9

(57) ABSTRACT

A modular wind turbine is formed from a plurality of micro core wind turbines that may be assembled to form a plurality of micro wind turbine units. The micro wind turbine units may be differently arrayed and assembled to create different configurations for the modular wind turbine, so that the modular wind turbine with multiple micro wind turbine units may be conveniently used in daily life and mounted on a head or a roof of a vehicle to convert wind power into electric energy for use.

### FIELD OF THE INVENTION

The present invention relates to a modular wind turbine with multiple micro wind turbine units, and more particularly to an assembly for capturing energy from wind force via a plurality of micro wind turbine units, each of which includes more than one micro core wind turbine to enable large wind area and convenient use of the apparatus in daily life at different places allowing wind generation.

### BACKGROUND OF THE INVENTION

In response to the worldwide efforts of energy saving, large-scale wind generators, or briefly referred to as wind turbines, have been rapidly developed and widely accepted in recently years. However, since the large-scale wind turbines would occupy a relatively large space for operation and it is uneasy to find such large places suitable for wind generation, the conventional wind turbines are usually erected at a vast open places, such as by the seashore, on the sea, or in a swamp, so as to collect sufficient wind force for obtaining wind energy. It is uneasy to maintain the large-scale wind turbines while the-environmental ecologies surrounding the wind turbines tend to be damaged. Particularly, a lot of environmentalist show deep concern at the interference on habitats of migratory birds by the wind turbines.

It is therefore tried by the inventor to develop a novel modular wind turbine with multiple micro wind turbine units to eliminate the drawbacks existed in the conventional large-scale wind turbines.

### SUMMARY OF THE INVENTION

A primary object of the present invention is to provide a modular wind turbine that includes a plurality of micro wind turbine units, each of which is formed from more than one micro core wind turbine, so that the a plurality of micro wind turbine units maybe differently arrayed and assembled according to actual need to form a calandria type, a block type, or a tilting type modular wind turbine for convenient use as a wind generator in daily life to convert wind force into electric energy.

Another object of the present invention is to provide a modular wind turbine with multiple micro wind turbine units, which is a wind energy capturing apparatus and may have different configurations depending on the actual dimensions of a space available for mounting the modular wind turbine. The modular wind turbine includes a plurality of serially or parallelly connected micro wind turbine units, and may be flexibly mounted at any place forming a wind field or be actively approached to a wind field. Based on the principle that the wind energy is in direct proportion to the wind area, the use of the modular wind turbine with multiple micro wind turbine units according to the present invention is not restricted to specific positions.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view of a micro core wind turbine for forming the present invention;

FIG. 2 is a conceptual view of a micro wind turbine unit formed from more than one micro core wind turbine of FIG. 1 for use in the present invention;

FIG. 3 is a conceptual view of a block-type modular wind turbine with multiple micro wind turbine units according to the present invention;

FIG. 4 is a conceptual view of a revolving modular wind turbine with multiple micro wind turbine units according to the present invention;

FIG. 5 is a conceptual view of a calandria-type modular wind turbine with multiple micro wind turbine units according to the present invention;

FIG. 6 is a conceptual view of an irregularly-shaped modular wind turbine with multiple micro wind turbine units according to the present invention; and

FIG. 7 is a conceptual view of a rooftop modular wind turbine with multiple micro wind turbine units according to the present invention.

### DETAILED DESCRIPTION OF THE PREFERRED EMBODIMENTS

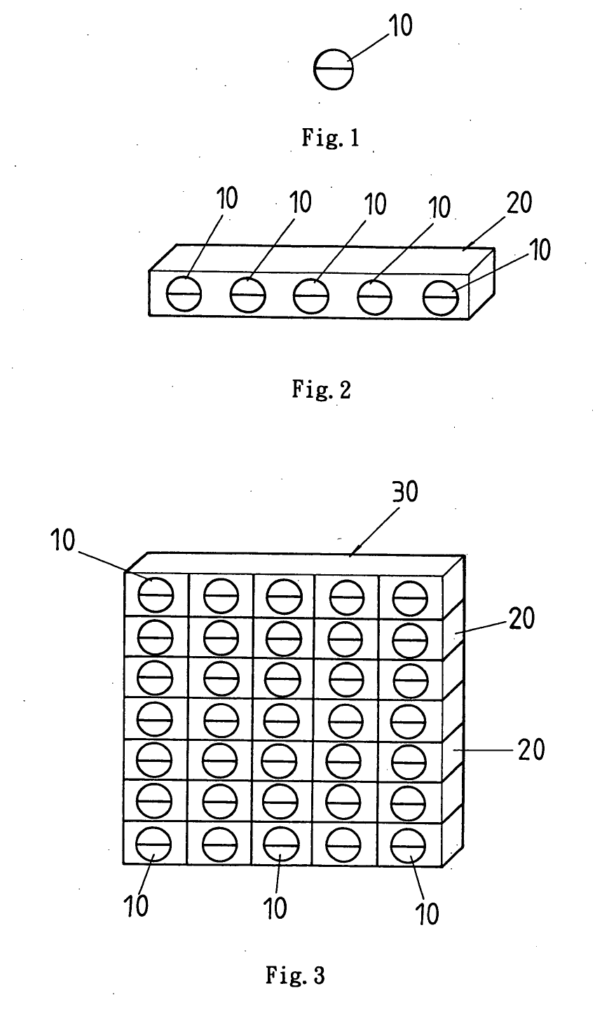

Please refer to FIG. 1 that is a conceptual view of a micro core wind turbine 10 for forming a modular wind turbine with multiple micro wind turbine units of the present invention. Parts and components provided at a rear end of the micro core wind turbine 10 may be similar to those for the electronic control module of a solar cell, so as to employ the principle of converting wind power into electric energy. Since the technology of converting wind power into electric energy is known, it is not discussed in details herein.

Please refer to FIG. 2 that is a conceptual view of a micro wind turbine unit 20 consisting of more than one micro core wind turbines 10 shown in FIG. 1.

FIG. 3 is a conceptual view of a block-type modular wind turbine with multiple micro wind turbine units 30 formed from a plurality of micro wind turbine units 20 of FIG. 2 that are stacked to form a matrix.

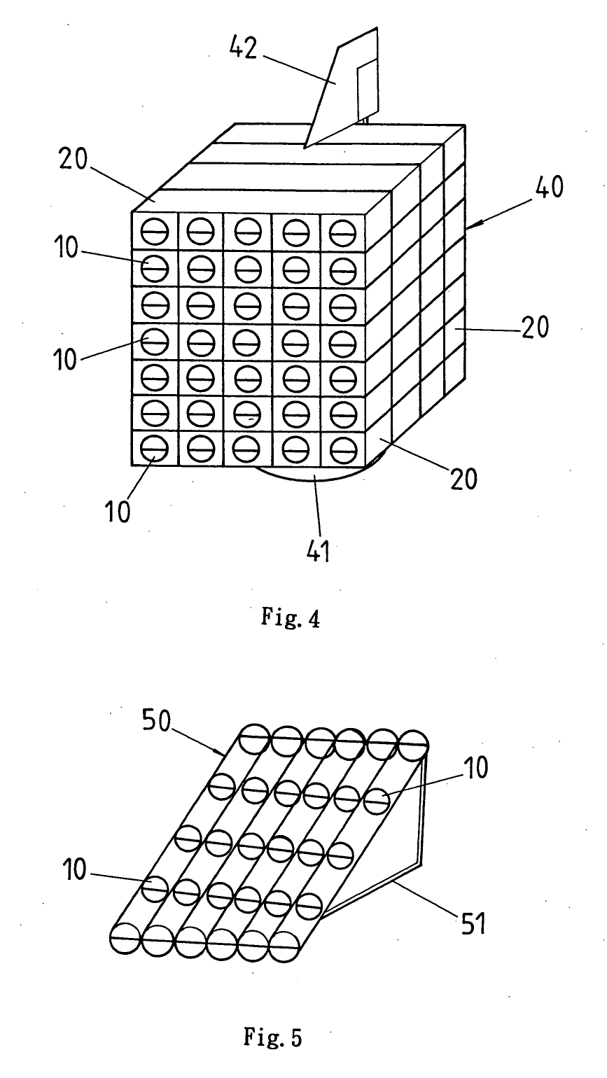

FIG. 4 is a conceptual view of a revolving modular wind turbine with multiple micro wind turbine units 40 formed from a plurality of stacked micro wind turbine units 20. As shown, the revolving modular wind turbine with multiple micro wind turbine units 40 includes a rotary disk 41 mounted to a bottom thereof, and a rudder 42 located above a top thereof. The revolving modular wind turbine with multiple micro wind turbine units 40 is automatically revolvable or may be rotated under electrical control within 360 degrees, and may be oriented to different directions via the rudder 42.

FIG. 5 is a conceptual view of a calandria-type modular wind turbine with multiple micro wind turbine units 50 consisting of a plurality of micro core wind turbines 10 installed in tilting tubes. An angle-adjustable support 51 is connected to a rear side of the calandria-type modular wind turbine with multiple micro wind turbine units 50, so that the latter may be mounted to a head or other suitable place of a cargo truck or a trailer truck to serve as a spoiler and a wind turbine at the same time.

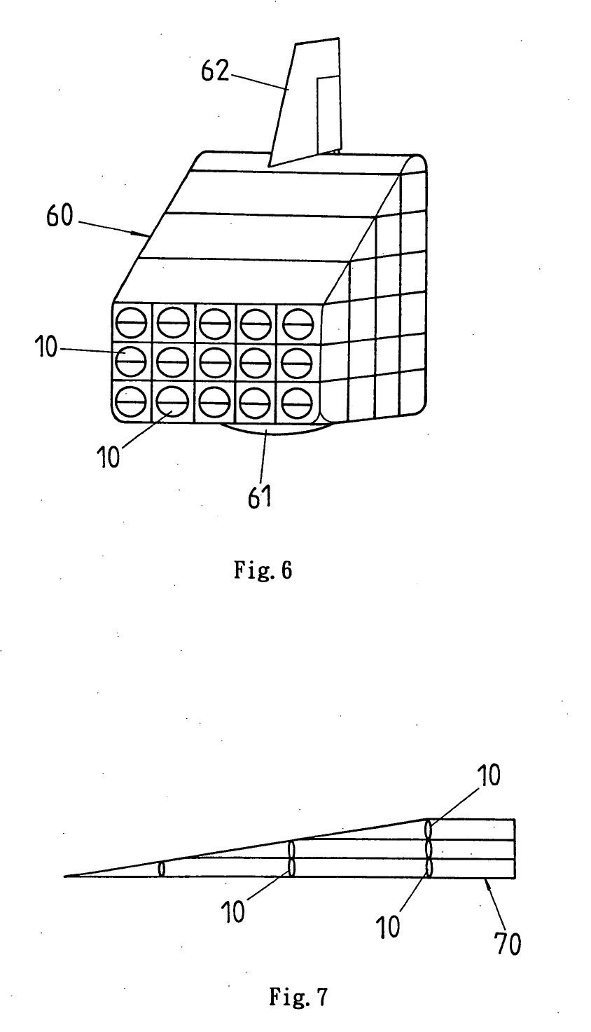

Please refer to FIG. 6 that is a conceptual view of an irregularly shaped modular wind turbine with multiple micro wind turbine units 60 formed from a plurality of micro core wind turbines 10 to look like a penthouse. The modular wind turbine with multiple micro wind turbine units 60 also includes a rotary disk 61 connected to a bottom thereof, and a rudder 62 located above a top thereof, and is suitable for positioning on a balcony of a general house.

FIG. 7 is a conceptual view of a rooftop modular wind turbine with multiple micro wind turbine units 70 consisting of a plurality of micro core wind turbines 10 and suitable for mounting on a roof of a vehicle, so that the high-speed wind force produced during driving maybe utilized and converted into an auxiliary electric energy for the vehicle.

In brief, in the present invention, modular wind turbines with multiple micro wind turbine units in different forms may be created from more than one micro core wind turbine 10 or more than one micro wind turbine unit 20 for use in daily life as a popularized wind generator to convert wind power into electric energy. The present invention is therefore practical and effective for use.

What is claimed is:

1. A modular wind turbine with multiple micro wind turbine units, comprising a plurality of micro core wind turbines, which may be assembled to form a plurality of micro wind turbine units; wherein said micro core wind turbines and said micro wind turbine units may be differently arrayed and assembled to create different configurations for said modular wind turbine; whereby said modular wind turbine with multiple micro wind turbine units is suitable for use in daily life to convert wind power into electric energy.

2. The modular wind turbine with multiple micro wind turbine units as claimed in claim 1, further comprising a rotary disk mounted below said modular wind turbine, such that said modular wind turbine is revolvable; and a rudder located above said modular wind turbine for orienting said modular wind turbine to different directions.

3. The modular wind turbine with multiple micro wind turbine units as claimed in claim 1, wherein said modular wind turbine is mounted to a head of a vehicle to serves as a spoiler and a wind turbine at the same time.

4. The modular wind turbine with multiple micro wind turbine units as claimed in claim 1, wherein said modular wind turbine is mounted on a roof of a vehicle, so that high-speed wind force produced during driving of the vehicle is converted into an auxiliary electric energy for the vehicle.
